(19) United States
(12) Patent Application Publication
(10) Pub. No.: US 2025/0334138 A1
(43) Pub. Date: Oct. 30, 2025

(54) Nut For Mechanically Interlocking A Component To A T-Slot Frame Member

(71) Applicant: Frank E. Oetlinger, Grafton, WI (US)

(72) Inventor: Frank E. Oetlinger, Grafton, WI (US)

(21) Appl. No.: 18/651,042

(22) Filed: Apr. 30, 2024

(51) Int. Cl. F16B 7/04

(52) U.S. Cl. CPC F16B 7/0446

(57) ABSTRACT

A nut is provided for mechanically interlocking a component to a t-slot frame member. The component is positionable on the t-slot frame member and the nut is receivable in a t-slot in the frame member. The nut includes first and second shoulder surfaces extending outwardly from each other and lying in a common plane. A rib projects from the first shoulder surface. A bolt extending through a bore in the component and is threadable into a threaded bore in the nut. The threading of the bolt into the threaded bore draws the first shoulder surface toward a first abutment wall defining the t-slot such that the rib engages the first abutment wall.

### FIELD OF THE INVENTION

This invention relates generally to structural frame assemblies for automation equipment and the like, and in particular, to nut for mechanically interlocking a component of a framing assembly to a frame member having a t-shaped slot running along the length thereof.

### BACKGROUND AND SUMMARY OF THE INVENTION

As is known, structural frames are used in the construction of a wide variety of products, including everything from automation equipment and furniture to buildings and the like. Structural frames typically incorporate horizontal and vertical frame members tied together by corner pieces, joints or bonding. Typically, these frame members take the form of extruded aluminum profiles with t-shaped slots that run along the length of the profiles. The slots in the frame members allow for t-nuts and other fasteners to be slid into position, thereby providing customizable connection point for various components.

While functional for their intended purpose, the fasteners used to interconnect various components of the structural frame to the frame members utilize friction to maintain the connection therebetween. For example, conventional nut and bolt combinations are often used to secure the components and the frame members together. However, these conventional nut and bolt combinations holding the structural frames together often come loose over time when subjected to vibration and/or the environment. As the nut and bolt combinations loosen, the integrity of the structural frame may be compromised. Further, as the nut and bolt combinations loosen, the frame members and the components interconnected thereto are allowed to rotate with respect to one another, thereby compromising the alignment and the integrity of the structural frame.

In order to overcome the limitations associated with the use of friction-type fasteners, specialized fasteners and frame members have been developed. By way of example, Oetlinger, U.S. Pat. No. 9,016,972 discloses a structural frame assembly that includes joints with mechanical interfaces in engagement with each other which allows the joint components to mechanically align themselves while being tightened. This automatic and self-aligning capability of the various components allows for the joints of the structural frame assembly to restore to their precisely fitted positions or “return to zero” when the structural frame assembly enters a relaxed state after being subjected to loads and/or vibration. This arrangement, in turn, prevents the structural frame assembly from being skewed out of its precision setup position during use by absorbing loads primarily through, for example, bending of rails instead of face-to-face pivotal slip of components, about orthogonally extending fasteners, at joints. This arrangement also allows the interfacing components of the joints of the structural frame assembly to further seat against each other during use while being subjected to loading, unloading, and vibrations, in preference to pivoting out of alignment, which enhances, or at least maintains, the alignment integrity of the joint.

While the frame assembly and components disclosed in the Oetlinger '972 patent provide a significant structural advantage over the prior art, adoption by the market has been limited due to the widespread manufacture and use of frame members with t-shaped slots. Hence, there exists a need to develop a fastening mechanism which allows for components to be mechanically interlocked to frame members having a t-shaped slots and which maintains the components interlocked to the frame members during repeated use.

Therefore, it is a primary object and feature of the present invention to provide a nut which allows for components to be mechanically interlocked to frame members having a t-shaped slots and which maintains the components interlocked to the frame members during repeated use.

It is a further object and feature of the present invention to provide a nut which allows for components to be simply and easily mechanically interlocked to frame members having t-shaped slots to form a structural frame assembly.

It is a still further object and feature of the present invention to provide a nut which allows for components to be simply and easily connected to frame members having t-shaped slots to facilitate the construction of structural frame assemblies for a variety of uses.

In accordance with present invention, a nut is provided for mechanically interlocking a component to a t-slot frame member. The component has a bore extending angularly therethrough. The t-slot frame member includes a t-shaped slot defined by first and second sidewalls extending from a face at angles generally perpendicular to the face and first and second abutment walls lying in a common plane and extending away from each other in opposite directions from corresponding terminal edges of first and second sidewalls. The nut includes a substantially flat upper wall extending along an axis and having first and second side edges. A first side depends from the first side edge and a second side depending from the second side edge. First and second shoulder surfaces extend outwardly from lower portions of corresponding first and second sides. The first and second shoulder surfaces lie in a common plane. A rib projects from the first shoulder surface. The rib is engageable with the first abutment wall.

The rib is defined by an apex having first and second sides extending from the apex. The first and second sides of the rib diverge from each other as the first and second sides of the rib extend from the apex. The first shoulder surface includes a generally concave first recess therein. The first recess extends along an axis generally parallel to the axis of the upper wall and is positioned adjacent to the first side of the rib. The first shoulder surface includes a generally concave second recess therein. The second recess extends along an axis generally parallel to the axis of the upper wall and is positioned adjacent to the second side of the rib.

The nut also includes first and second end surfaces. The first and second end surfaces are interconnected by and generally perpendicular to the upper wall. A bottom surface extends between the first and second end surfaces. The bottom surface lies in a plane at an acute angle to the upper wall. A bore extends angularly between the upper wall and the bottom surface.

In accordance with a further aspect of the present invention, a nut is provided for mechanically interlocking a component to a t-slot frame member. The component has a bore extending angularly therethrough. The t-slot frame member includes a t-shaped slot defined by first and second sidewalls extending from a face at angles generally perpendicular to the face and first and second abutment walls lying in a common plane and extending away from each other in opposite directions from corresponding terminal edges of first and second sidewalls. The nut includes first and second end faces lying in corresponding parallel planes. A substantially flat upper wall interconnects the first and second end faces and has first and second side edges. A first side depends from the first side edge and a second side depends from the second side edge. First and second shoulder surfaces extend outwardly from lower portions of corresponding first and second sides. The first and second shoulder surfaces lie in a common plane. A bottom surface extends between the first and second end surfaces. The bottom surface lies in a plane at an acute angle to the upper wall. A bore extends between the upper wall and the bottom surface.

A rib projects from the first shoulder surface. The rib is engageable with the first abutment wall. The rib is defined by an apex and first and second sides extending from the apex. The first and second sides of the rib diverge from each other as the first and second sides of the rib extend from the apex.

The first shoulder surface includes a generally concave first recess therein. The first recess extends along an axis generally parallel to the axis of the upper wall and is positioned adjacent to the first side of the rib. The first shoulder surface includes a generally concave second recess therein. The second recess extends along an axis generally parallel to the axis of the upper wall and is positioned adjacent to the second side of the rib. The bore of the nut extends angularly between the upper wall and the bottom surface.

In accordance with a still further aspect of the present invention, a frame assembly is provided. A t-slot frame member extends along an axis. The t-slot frame member includes a generally flat face and a t-shaped shot defined by first and second sidewalls extending from the face at angles generally perpendicular to the face. First and second abutment walls lie in a common plane and extend away from each other in opposite directions from the first and second sidewalls. A component has a bore extending angularly therethrough. The component is positionable against the face such the bore communicates with the t-shaped slot. A nut is positonable in the slot. The nut includes a substantially flat upper wall extending along an axis and has first and second side edges. A threaded bore communicating with upper wall. A first side depends from the first side edge and a second side depends from the second side edge. First and second shoulder surfaces extend outwardly from lower portions of corresponding first and second sides. The first and second shoulder surfaces lie in a common plane. A rib projects from the first shoulder surface. The rib is engageable with the first abutment wall. A bolt extends through the bore in the component and is threaded into the threaded bore of the nut. The threading of the bolt into the threaded bore of the nut draws the first shoulder surface toward the first abutment wall such that the rib engages the first abutment wall.

The rib is defined by an apex and first and second sides extending from the apex. The first and second sides of the rib diverge from each other as the first and second sides of the rib extend from the apex. The first shoulder surface includes a generally concave first recess therein. The first recess extends along an axis generally parallel to the axis of the upper wall and is positioned adjacent to the first side of the rib. The first shoulder surface includes a generally concave second recess therein. The second recess extends along an axis generally parallel to the axis of the upper wall and is positioned adjacent to the second side of the rib. The nut also includes first and second end surfaces. The first and second end surfaces are interconnected by and generally perpendicular to the upper wall. A bottom surface extends between the first and second end surfaces. The bottom surface lies in a plane at an acute angle to the upper wall. The threaded bore extends angularly between the upper wall and the bottom surface.

### BRIEF DESCRIPTION OF THE DRAWINGS

The drawings furnished herewith illustrate a preferred construction of the present invention in which the above advantages and features are clearly disclosed, as well as others which will be readily understood from the following description of the illustrated embodiment.

In the drawings:

FIG. 1 is an exploded, isometric view of a frame assembly utilizing a nut in accordance with the present invention;

FIG. 2 is an isometric view of a frame assembly constructed utilized the nut of the present invention;

FIG. 3 is a cross-sectional view of the frame assembly constructed utilized the nut of the present invention taken along line 3-3 of FIG. 2;

FIG. 3A is an end view of a t-slot frame member of the frame assembly of FIG. 1;

FIG. 4 is a rear elevational view of the frame assembly of FIG. 2;

FIG. 5 is a front elevational view of the frame assembly of FIG. 2;

FIG. 6 is a side elevational view of a first side of the frame assembly of FIG. 2;

FIG. 7 is a side elevational view of a second side of the frame assembly of FIG. 2;

FIG. 8 is an isometric view of a variant of a nut in accordance with the present invention;

FIG. 9 is a front elevational view of the nut of FIG. 8;

FIG. 10 is a rear elevational view of the nut of FIG. 8;

FIG. 11 is a side elevational view of a first side of the nut of FIG. 8;

FIG. 12 is a side elevational view of a second side of the nut of FIG. 8;

FIG. 13 is a top plan view of the nut of FIG. 8; and

FIG. 14 is a bottom plan view of the nut of FIG. 8.

### DETAILED DESCRIPTION OF THE DRAWINGS

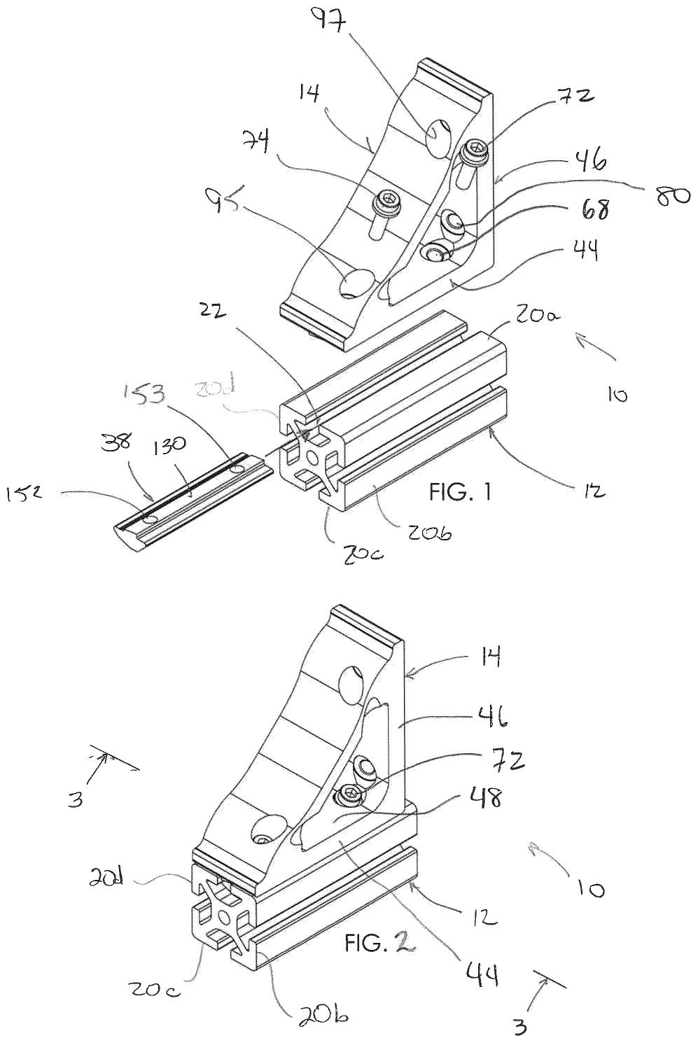

Referring to FIGS. 1-2, a frame assembly constructed utilizing a nut in accordance with the present invention is generally designated by the numeral 10. As hereinafter described, frame assembly 10 includes a component, such as corner piece 14, interconnected to t-slot frame member 12 by means of a bolt and nut combination, as hereinafter described. As hereinafter described, various components may by interconnected to t-slot frame member 12 so as to construct frame assemblies of various configurations. As such, frame assembly 10 is merely exemplary of the type of frame assembly that may be constructed utilizing the nut of the present invention. Other configurations of frame assembly 10 are contemplated as being within the scope of the present invention.

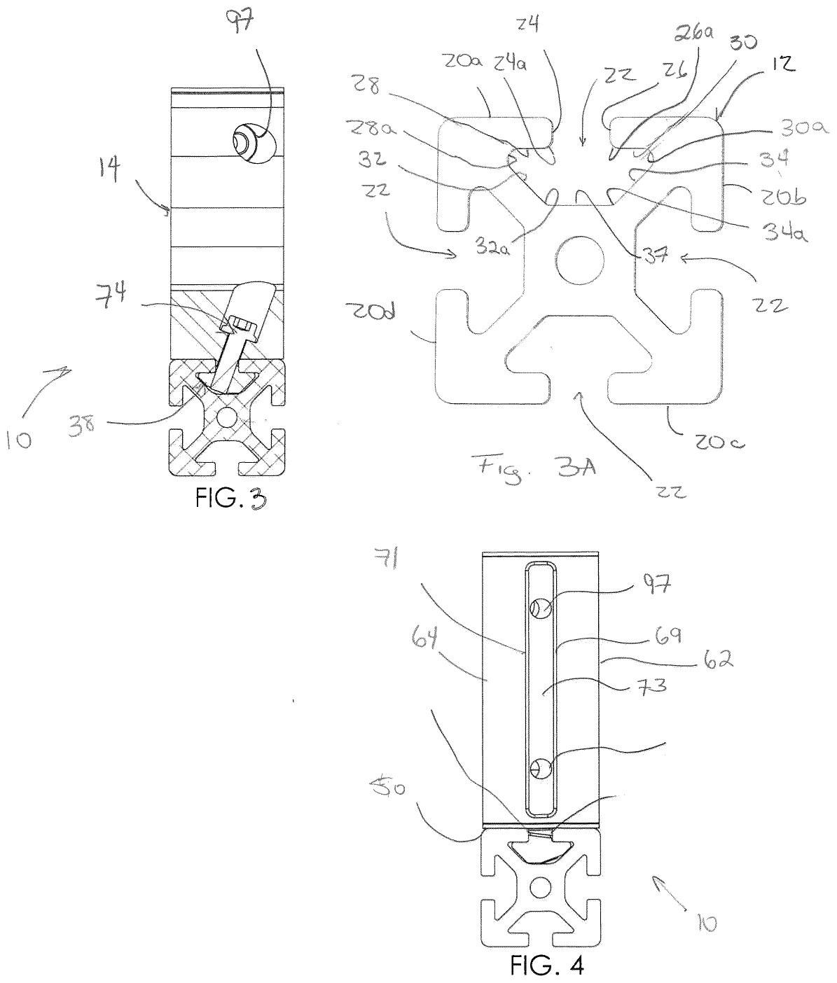

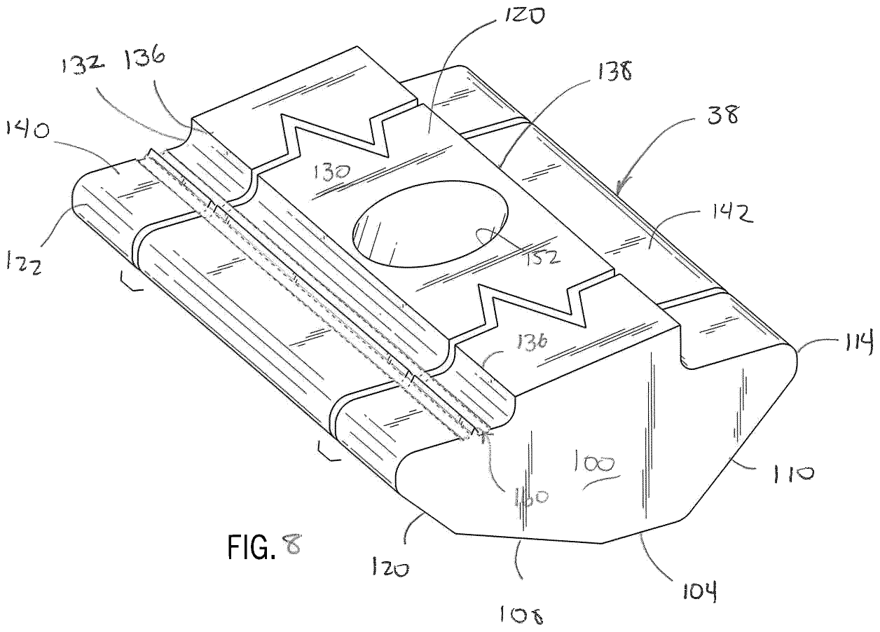

As best seen in FIG. 3A, t-slot frame member 12 has a generally square configuration and extends along longitudinal axis 21, FIGS. 6-7. T-slot frame member 12 is defined by four faces 20a-20d. Each face 20a-20d is identical in structure, and as such, the description hereinafter of face 20a is understood to describe faces 20b-20d, as if fully described herein. Face 20a of T-slot frame member 14 is generally flat and includes slot 22 therein that extends along the entire length thereof.

Slot 22 in face 20a of t-slot frame member 14 is defined by first and second sidewalls 24 and 26, respectively, extending from face 20a at angles generally perpendicular to face 20a. Slot 22 is further defined by first and second abutment walls 28 and 30, respectively, which lie in a common plane and extend away from each other in opposite directions from corresponding terminal edges 24a and 26a, respectively, of first and second sidewalls 24 and 26, respectively. First and second inner walls 32 and 34, respectively, extend from corresponding terminal edges 28a and 30a, respectively, of first and second abutment walls 28 and 30, respectively, and terminate at terminal ends 32a and 34a, respectively. In addition, first and second inner walls 32 and 34, respectively, converge toward each other as first and second inner walls 32 and 34, respectively, extend toward terminal ends 32a and 34a, respectively. Generally flat, terminal wall 37 extends between terminal ends 32a and 34a of first and second inner walls 32 and 34, respectively. Terminal wall 37 lies in a plane generally parallel to the plane of first and second abutment walls 28 and 30, respectively. Slot 22 is configured to receive nut 38 therein, as hereinafter described.

Frame assembly 10 further includes one or more components interconnected t-slot frame member 12. For example, the component may take the form of a covering, such as a panel, that may be secured to t-slot frame member 12 to isolate the interior of frame assembly 10 and/or to provide an aesthetically pleasing appearance. Alternatively, various components may be interconnected to frame assembly 10 to allow frame assembly 10 to be used for its intended purpose. By way of example, hinges may be interconnected to T-slot frame member 12 to function as a drawer. It can be appreciated that other types of components may be interconnected to the structural frame to facilitate the intended purpose thereof. Further, it contemplated for the component to be, in turn, connectable to an alternate frame member, such as disclosed in Oetlinger, U.S. Pat. No. 9,016,972.

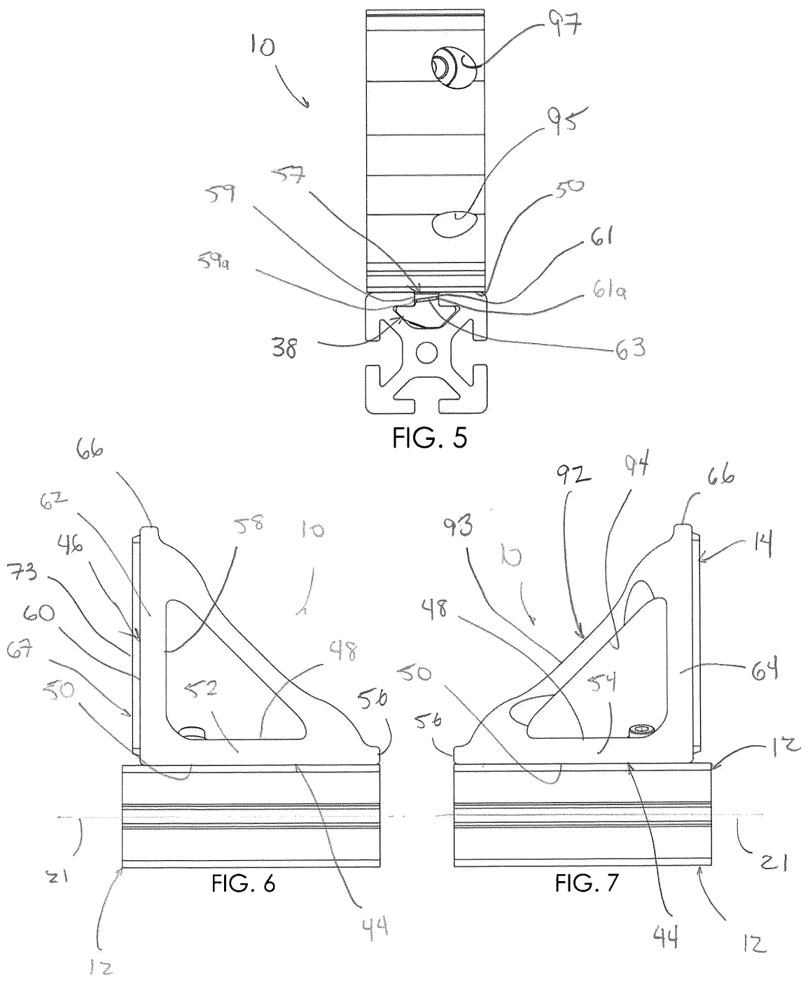

In the depicted embodiment, the component is depicted as corner piece 14. However, as noted above, it can be appreciated that the component may have other forms or configurations without deviating from the scope of the present invention. Referring to FIGS. 1-7, corner piece 14 includes an L-shaped body defined by horizontal plate member 44 and an upright or vertical plate member 46. Horizontal plate member 44 defines a substantially flat inner face 48, a substantially flat outer face 50, first and second side faces 52 and 54, respectively, and end face 56. Each of these faces are substantially planar in shape.

Rib 57 depends from outer face 50 of horizontal plate member 44 and includes first side 59 spaced from first side face 52 and generally perpendicular to outer face 50 and second side 61 spaced from second side face 54 generally perpendicular to outer face 50. Generally flat, lower face 63 of rib 57 extends angularly from terminal edge 59a of first side 59 to terminal edge 61a of second side 61 so as to form a mating relationship with upper surface 120 of nut 38, as hereinafter described.

Horizontal plate member 44 has an angularly extending bolt receiving bore 68 formed therethrough that extends between inner face 48 and lower face 63 of rib 57. Bore 68 defines an axis disposed at an acute angle with respect to inner face 58 of horizontal plate member 44. It is preferred that the acute angle fall in the range of 1° and 89°, but preferably between about 30° and about 80°, and is most preferably about 65°. Bolt 72 is intended to extend through bore 68 in horizontal plate member 44 into slot 22 in first face 20a of T-slot frame member 12, for reasons hereinafter described.

Upright or vertical plate member 46 also defines a substantially flat inner face 58, a substantially flat outer face 60, first and second side faces 62 and 64, respectively, and end face 66. Rib 67 depends from outer face 60 of upright or vertical plate member 46 and includes first side 69 spaced from first side face 62 and generally perpendicular to outer face 60 and second side 71 spaced from second side face 64 and being generally perpendicular to outer face 60. Generally flat, lower face 73 of rib 67 extends angularly from terminal edge 69a of first side 69 to terminal edge 71a of second side 71 so as to form a mating relationship with upper surface 120 of a corresponding nut 38.

Upright or vertical plate member 46 of corner piece 14 further includes an angularly extending bolt receiving bore 80 formed therethrough from inner face 58 to lower face 73 of rib 67 through which a corresponding bolt (not shown) can extend. Bore 80 through upright or vertical plate member 46 of corner piece 14 extends along corresponding axes and is disposed at an acute angle with respect to the inner face 58 of vertical plate member 46. Again, this acute angle may be anywhere between 1° and 89°, but is preferably between about 30° and about 80°, and is most preferably about 65°. A bolt (not shown) and nut 38 combination may be utilized to connect corner piece 14 to a second frame member, e.g. t-slot frame member 12.

Corner piece 14 further includes gusset 92 extending between inner face 48 of horizontal plate member 44 adjacent end face 56 thereof and inner face 58 of vertical plate member 46 adjacent end face 66 thereof. Gusset 92 includes inner face 94 directed toward inner faces 48 and 58 of horizontal plate member 44 and upright or vertical plate member 46, respectively, and outer face 93. Gusset 92 further includes a pair of spaced angularly extending bolt receiving bores 95 and 97 formed therethrough. Bore 95 is disposed adjacent end face 56 of horizontal plate member 44 and extends between outer face 93 and lower face 63 of rib 57. Bore 95 extends along an axis generally parallel to the axis of bore 68 through horizontal plate member 44 at an acute angle with respect to inner face 58 of horizontal plate member 44. It is preferred that the acute angle fall in the range of 1° and 89°, but preferably between about 30° and about 80°, and is most preferably about 65°. Bolt 74 is provided to extend through corresponding bore 95 into slot 22 in first face 20a of t-slot frame member 12, for reasons hereinafter described.

Bore 97 is disposed adjacent end face 66 of vertical plate member 46 and extends between outer face 93 of gusset 92 and lower face 73 of rib 67. Bore 97 extends along an axis generally parallel to the axis of bore 78 through vertical plate member 46 at an acute angle with respect to inner face 68 of vertical plate member 44. It is preferred that the acute angle fall in the range of 1° and 89°, but preferably between about 30° and about 80°, and is most preferably about 65°. A bolt may extend through corresponding bore 97 into slot 22 in first face 20a of a second frame member, e.g. t-slot frame member 12.

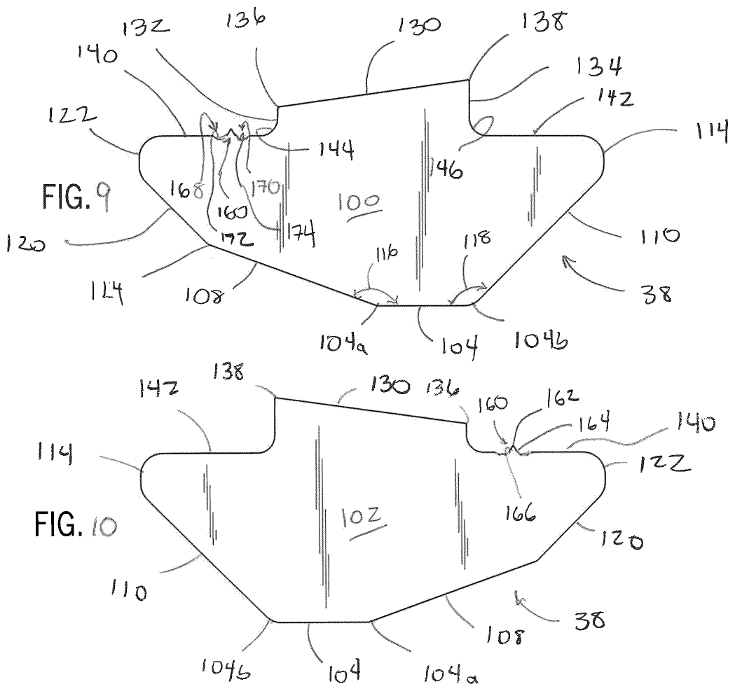

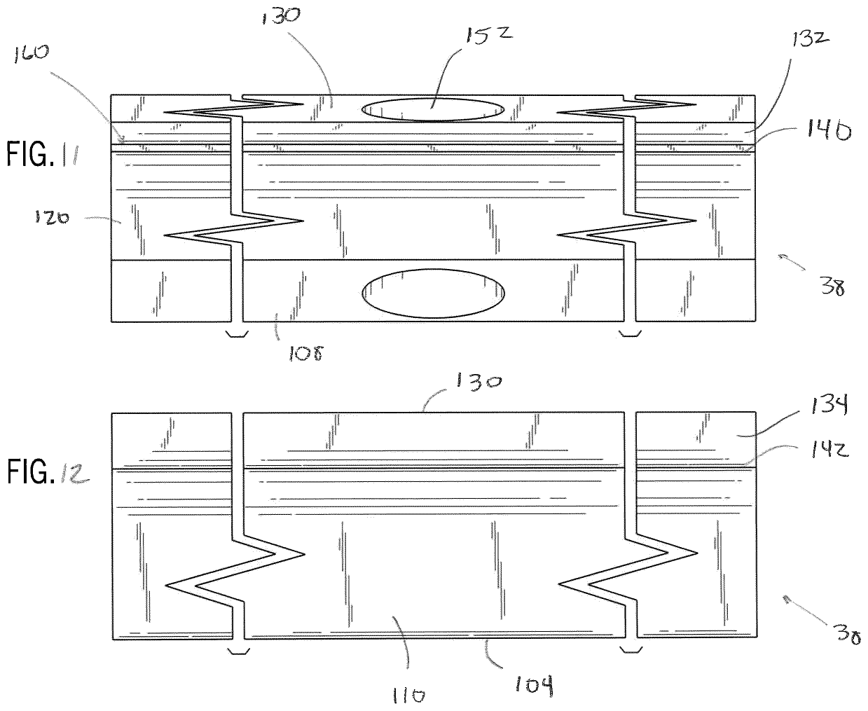

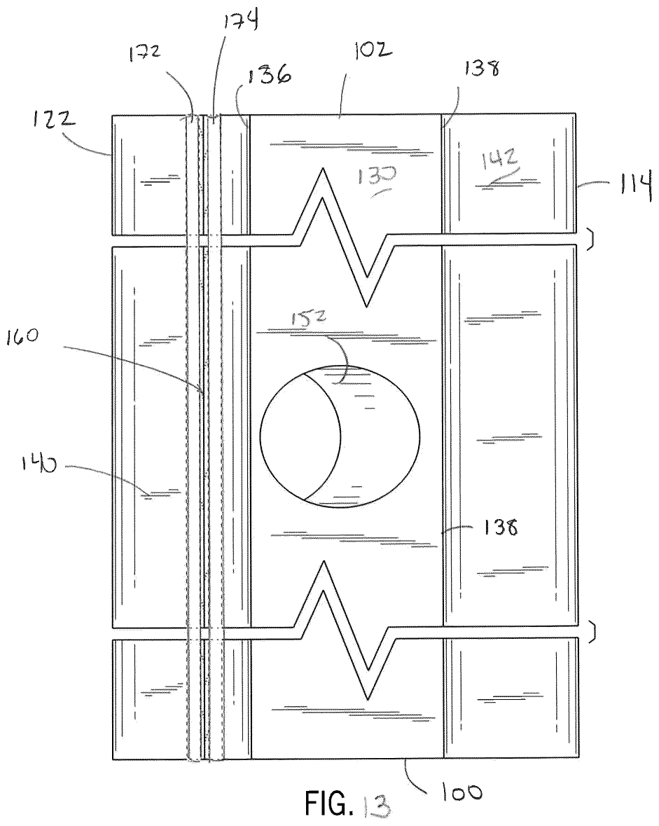

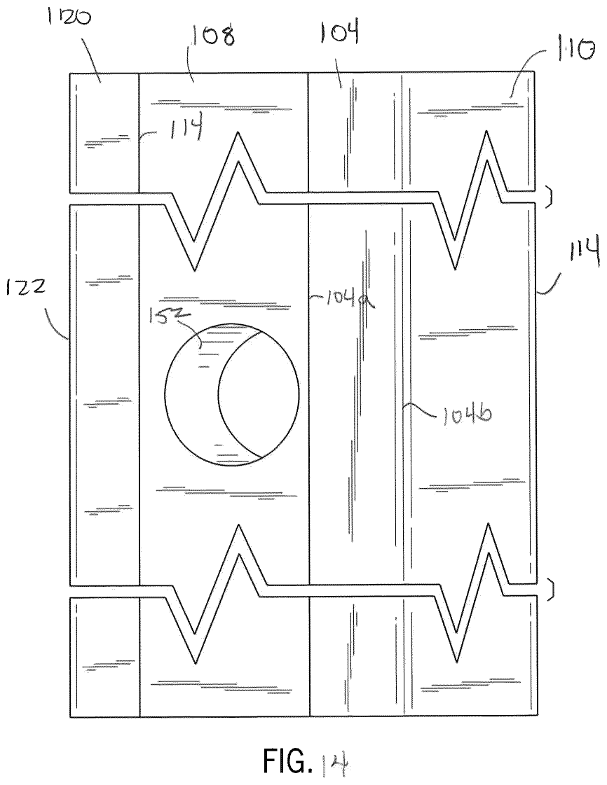

Referring to FIGS. 1 and 8-13, it is contemplated for nut 38 to be provided within slot 22 in first face 20a of t-slot frame member 12 and threaded onto the shafts of corresponding bolts so as to rigidly connect corner piece 40 to t-slot frame member 12. Nut 38 may be fabricated to be different lengths and may include one of more bores therethrough. By way of example, nut 38 extends along an axis and is defined by first and second end faces 100 and 102, respectively. First and second end faces 100 and 102, respectively, are spaced by a generally flat bottom surface 104 having first and second, generally parallel edges, 104a and 104b, respectively. First and second, generally flat, lower surfaces 108 and 110, respectively, extend from corresponding edges 104a and 104b, respectively, at corresponding obtuse angles 116 and 118, respectively, to bottom surface 104 wherein angle 116 is greater than angle 118. First and second lower surfaces 108 and 110, respectively, diverge from each other and terminate at corresponding edge 112 and rounded corner 114, respectively. Generally flat, upper surface 120 extends from edge 114 of lower surface 100 and terminates at a corresponding rounded corner 122.

Nut 38 further includes a substantially flat upper wall 130 interconnecting first and second end faces 100 and 102, respectively, and having first and second side edges, 136 and 138, respectively. Upper wall 130 lies in a plane at an acute angle to the plane in which bottom surface 104 lies. First side 132 depends from first side edge 136. Second side 134 depends from second side edge 138 at an acute angle thereto. First and second shoulder surfaces 140 and 142, respectively, extend outwardly from lower portions of corresponding sides 134 and 134, respectively, and are interconnected thereto by corresponding, generally concave corners 144 and 146, respectively. First and second shoulder surfaces 140 and 142, respectively, lie in a common plane and are interconnected to upper surface 120 and edge 122 of lower surface 110, respectively, by corresponding, generally convex rounded corners 122 and 114, respectively.

First shoulder surface 140 includes rib 160 projecting therefrom. Rib first 160 extends between first and second end faces 100 and 102, respectively, and is defined by apex 162 having diverging, first and second sides 164 and 166, respectively depending therefrom. First and second channels 168 and 170, respectively are provided on opposite sides of rib 160. More specifically, first channel 168 is provided in first shoulder surface 140 and extends between first and second end faces 100 and 102, respectively. First channel 168 is defined by a generally concave surface 172 extending between first side 164 of rib 160 and first shoulder surface 140. Second channel 168 also extends between first and second end faces 100 and 102, respectively. Second channel 168 is defined by a generally concave surface 174 extending between second side 164 of rib 160 and first shoulder surface 140.

Referring to FIG. 1, in the depicted embodiment, nut 38 further includes a pair of threaded bores 152 and 153 that are spaced from each other along the length of nut 38. Threaded bores 152 and 153 extend angularly from upper wall 130 so as to intersect to bottom surface 104 and lower surface 108 of nut 38 in a transverse direction of the axis of nut 38 and at the same angles that bores 68 and 95 extend through corner piece 14 and that bores 80 and 97 extend through corner piece 14. Each of such acute angles of threaded bores 152 and 153 falls in the range of 1° and 89°, but is preferably between about 30° and about 80°, and is most preferably about 65° with respect to the upper wall 130 of the nut 38. In this configuration, each threaded bore 152 and 153 has an upper opening that communicates with upper wall 130 and a lower opening that communicates with bottom surface 104 and lower surface 108.

In order to interconnect corner piece 14 to T-slot frame member 12, corner piece 14 is positioned such that outer face 50 of horizontal plate member 44 engages face 20a of T-slot frame member 12 and such that rib 57 is received between first and second sidewalls 24 and 26, respectively, partially defining slot 22 in face 20a of t-slot frame member 12, FIGS. 2-7. Nut 38 is slid axially into slot 22 in T-shaped frame member 12 such that bolt receiving bores 68 and 70 are aligned with corresponding threaded bores 152 and 153 therein. Bolts 72 and 74 are inserted into corresponding bolt receiving bores 68 and 95 through corner piece 14, and threaded into corresponding threaded bores 152 and 153 in nut 38. As bolts 72 and 74 are threaded into corresponding threaded bores 152 and 153 in nut 38, first and second shoulder surfaces 140 and 142, respectively, are drawn toward and brought into engagement with corresponding first and second abutment walls 28 and 30, respectively, partially defining slot 22 and upper wall 130 is drawn toward lower face 63 of rib 57 of corner piece 14, FIGS. 3-5. As first shoulder surfaces 140 is drawn towards first abutment walls 28, rib 160 pierces and is urged into first abutment walls 28, thereby causing a portion of the material making up first abutment wall 28 to be forced into first and second channels 168 and 170, respectively provided on opposite sides of rib 160. With bolts 72 and 74 tighten into corresponding threaded bores 152 in nut 38, corner piece 14 is locked to T-shaped frame member 12 in multiple planes, thereby preventing the pivoting of corner piece 14 and T-shaped frame member 12 with respect to each other.

Various modes of carrying out the invention are contemplated as being within the scope of the following claims particularly pointing out and distinctly claiming the subject matter, which is regarded as the invention.

I claim:

1. A nut for mechanically interlocking a component to a t-slot frame member, the component having a bore extending angularly therethrough and the t-slot frame member including a t-shaped slot defined by first and second sidewalls, extending from a face at angles generally perpendicular to the face and first and second abutment walls lying in a common plane and extending away from each other in opposite directions from corresponding terminal edges of first and second sidewalls, comprising:
a substantially flat upper wall extending along an axis and having first and second side edges;
a first side depending from the first side edge;
a second side depending from the second side edge;
first and second shoulder surfaces extending outwardly from lower portions of corresponding first and second sides, the first and second shoulder surfaces lying in a common plane; and
a rib projecting from the first shoulder surface, the rib being engageable with the first abutment wall.

2. The nut of claim 1 further wherein the rib is defined by an apex having first and second sides extending from the apex, the first and second sides of the rib diverging from each other as the first and second sides of the rib extend from the apex.

3. The nut of claim 1 wherein the first shoulder surface includes a generally concave first recess therein, the first recess extending along an axis generally parallel to the axis of the upper wall and being positioned adjacent to the first side of the rib.

4. The nut of claim 3 wherein the first shoulder surface includes a generally concave second recess therein, the second recess extending along an axis generally parallel to the axis of the upper wall and being positioned adjacent to the second side of the rib.

5. The nut of claim 1 further comprising first and second end surfaces, the first and second end surfaces interconnected by and generally perpendicular to the upper wall.

6. The nut of claim 5 further comprising a bottom surface extending between the first and second end surfaces, the bottom surface lying in a plane at an acute angle to the upper wall.

7. The nut of claim 6 further comprising a bore extending angularly between the upper wall and the bottom surface.

8. A nut for mechanically interlocking a component to a t-slot frame member, the component having a bore extending angularly therethrough and the t-slot frame member including a t-shaped defined by first and second sidewalls, extending from a face at angles generally perpendicular to the face and first and second abutment walls lying in a common plane and extending away from each other in opposite directions from corresponding terminal edges of first and second sidewalls, comprising:
first and second end faces lying in corresponding parallel planes;
a substantially flat upper wall interconnecting the first and second end faces, the having first and second side edges;
a first side depending from the first side edge;
a second side depending from the second side edge;
first and second shoulder surfaces extending outwardly from lower portions of corresponding first and second sides, the first and second shoulder surfaces lying in a common plane;
a bottom surface extending between the first and second end surfaces, the bottom surface lying in a plane at an acute angle to the upper wall; and
a bore extending between the upper wall and the bottom surface.

9. The nut of claim 8 further comprising a rib projecting from the first shoulder surface, the rib being engageable with the first abutment wall.

10. The nut of claim 9 further wherein the rib is defined by an apex and first and second sides extending from the apex, the first and second sides of the rib diverging from each other as the first and second sides of the rib extend from the apex.

11. The nut of claim 10 wherein the first shoulder surface includes a generally concave first recess therein, the first recess extending along an axis generally parallel to the axis of the upper wall and being positioned adjacent to the first side of the rib.

12. The nut of claim 11 wherein the first shoulder surface includes a generally concave second recess therein, the second recess extending along an axis generally parallel to the axis of the upper wall and being positioned adjacent to the second side of the rib.

13. The nut of claim 8 wherein the bore of the nut extends angularly between the upper wall and the bottom surface.

14. A frame assembly, comprising:
a t-slot frame member extending along an axis, the t-slot frame member including:
a generally flat face;
a t-shaped shot defined by first and second sidewalls extending from the face at angles generally perpendicular to the face and first and second abutment walls lying in a common plane and extending away from each other in opposite directions from the first and second sidewalls;
a component having a bore extending angularly therethrough, the component positionable against the face such the bore communicates with the t-shaped slot;
a nut positonable in the slot, the nut including
a substantially flat upper wall extending along an axis and having first and second side edges;
a threaded bore communicating with upper wall;
a first side depending from the first side edge;
a second side depending from the second side edge;
first and second shoulder surfaces extending outwardly from lower portions of corresponding first and second sides, the first and second shoulder surfaces lying in a common plane;
a rib projecting from the first shoulder surface, the rib being engageable with the first abutment wall; and
a bolt extending through the bore in the component and threaded into the threaded bore of the nut;
wherein threading the bolt into the threaded bore of the nut draws the first shoulder surface toward the first abutment wall such that the rib engages the first abutment wall.

15. The nut of claim 14 further wherein the rib is defined by an apex and first and second sides extending from the apex, the first and second sides of the rib diverging from each other as the first and second sides of the rib extend from the apex.

16. The nut of claim 15 wherein the first shoulder surface includes a generally concave first recess therein, the first recess extending along an axis generally parallel to the axis of the upper wall and being positioned adjacent to the first side of the rib.

17. The nut of claim 16 wherein the first shoulder surface includes a generally concave second recess therein, the second recess extending along an axis generally parallel to the axis of the upper wall and being positioned adjacent to the second side of the rib.

18. The nut of claim 14 further comprising first and second end surfaces, the first and second end surfaces interconnected by and generally perpendicular to the upper wall.

19. The nut of claim 18 further comprising a bottom surface extending between the first and second end surfaces, the bottom surface lying in a plane at an acute angle to the upper wall.

20. The nut of claim 19 wherein the threaded bore extends angularly between the upper wall and the bottom surface.
